(19) United States
(12) Patent Application Publication
(10) Pub. No.: US 2023/0009713 A1
(43) Pub. Date: Jan. 12, 2023

(54) DELIVERY METHOD AND SYSTEM USING AN AUTONOMOUS MOBILITY DEVICE

(71) Applicants: HYUNDAI MOTOR COMPANY, Seoul (KR); KIA CORPORATION, Seoul (KR)

(72) Inventors: Dong Eun Cha, Hwaseong-si (KR); Jin Young Yoon, Gimpo-si (KR)

(73) Assignees: HYUNDAI MOTOR COMPANY, Seoul (KR); KIA CORPORATION, Seoul (KR)

(21) Appl. No.: 17/744,204

(22) Filed: May 13, 2022

(30) Foreign Application Priority Data
Jul. 6, 2021 (KR) 10-2021-0088479

(51) Int. Cl. B60W 60/00; G06F 21/31; G06Q 10/02; G06Q 50/30; G06Q 30/02; B60R 25/10; B60R 25/30

(52) U.S. Cl. CPC B60W 60/00256; G06F 21/31; G06Q 10/02; G06Q 50/30; G06Q 30/0283; B60R 25/10; B60R 25/30

(57) ABSTRACT

Disclosed are a delivery method and a system using an autonomous mobility device for a delivery service. The delivery method and system improve reliability and security by use of an authentication procedure between the mobility device and a user, and also improve a feeling of satisfaction of the delivery service by satisfying a delivery request made by the user.

### CROSS REFERENCE TO RELATED APPLICATION

This application claims priority to and the benefit of Korean Patent Application No. 10-2021-0088479, filed on Jul. 6, 2021, the entire contents of which are incorporated herein by reference.

### BACKGROUND

### Field

The present disclosure relates to a delivery method and system using an autonomous mobility device.

### Description of the Related Art

The statements in this section merely provide background information related to the present disclosure and may not constitute prior art.

As an autonomous vehicle has recently been developed, various services using the autonomous vehicle have been provided.

Moreover, due to the development of information communication technology, various services using a communication terminal (a portable device) are possible.

The foregoing explained as the above background is intended merely to aid in the understanding of the background of the present disclosure, and is not intended to mean that the present disclosure falls within the purview of the related art that is already known to those having ordinary skill in the art.

### SUMMARY

The present disclosure provides a delivery method and system using an autonomous mobility device in which a delivery service is provided using a mobility device that enables autonomous driving, reliability based on use of a delivery service is secured through an authentication procedure between a mobility device and a user, and a feeling of satisfaction of a delivery service provided to a user who makes a request for delivery is improved.

The present disclosure provides a delivery method using an autonomous mobility device that is configured to perform an autonomous driving and has a storage space. The delivery method includes: a searching step of searching a mobility device into which a baggage is loadable on the basis of baggage information set by a user; a moving step of causing the searched mobility device to move to the user; an authenticating step of checking authentication of the user with respect to the mobility device; a storing step of opening a storage space of the mobility device when the authentication of the user is completed; and a delivering step of closing the storage space when the loading of the baggage of the user into the mobility device is completed, and causing the mobility to move to a delivery destination point set by the user.

In one form, the searching step may include receiving baggage information based on weight of the baggage and a size of the baggage from the user and searching the mobility device into which the baggage set by the user is loadable.

The searching step may include receiving information based on a delivery departure point and the delivery destination point and searching a mobility that is movable to the delivery destination point via the delivery departure point.

The searching step may include receiving requested delivery information based on a delivery departure time and a delivery arrival expected time of the user.

The searching step may include receiving requested delivery information based on express or slow delivery when the baggage is delivered.

The searching step may include the user receiving requested delivery information based on use of an independent mobility device or a common mobility device.

The delivery method using an autonomous mobility device may further include a requesting step of, when a movable mobility device is searched through the searching step, transmitting information about a charge to be paid in using the searched mobility device to the user, and the moving step may include causing the selected mobility device to move to the user when the user permits delivery using the mobility device in the requesting step.

The storing step may include checking a previous baggage loaded into the mobility device before the storage space of the mobility device is opened and identifying whether or not the previous baggage is changed after the storage space of the mobility device is opened.

The storing step may include generating a theft warning signal when it is identified that the previous baggage is changed.

The storing step may include, when the user loads a baggage in the storage space of the mobility device, checking the baggage loaded by the user, checking whether the loaded baggage is identical to the baggage information set by the user, and generating a non-identical warning signal when the loaded baggage is different from the set baggage information.

The delivery method using an autonomous mobility device may further include a receipt authenticating step of requesting receipt authentication to a recipient when delivery of the baggage to the delivery destination point is completed after the delivering step, and opening the storage space of the mobility device when the receipt authentication is completed.

In another embodiment, the present disclosure provides a delivery method using an autonomous mobility device which is configured to perform an autonomous driving and in which a storage space thereof is divided into sectors according to a use purpose. In particular, the delivery method includes: a searching step of receiving information about use of a specific sector of the storage space in a mobility device selected by a user; a moving step of causing the selected mobility device to move to the user; an authenticating step of checking authentication of the user with respect to the mobility device; a storing step of opening the storage space of the mobility device when the authentication of the user is completed; and a delivering step of causing the mobility device to move to a delivery destination point set by the user when loading of the baggage into a specific sector selected by the user is completed.

The delivery method using an autonomous mobility device may further include a requesting step of, when the information about use of a specific sector of the storage space in a mobility device is input through the searching step, transmitting information about a charge to be paid in using the input specific sector to the user, and the moving step may include causing the selected mobility device to move to the user when the user permits delivery using the specific sector through the requesting step.

In another embodiment, the present disclosure provides a delivery system using an autonomous mobility device that is configured to perform an autonomous driving and has a storage space. In particular, the delivery system includes: a searching unit configured to receive baggage information and requested delivery information set by a user to search a movable mobility device; a first communication unit configured to cause the searched mobility device to move to the user; a second communication unit configured to check authentication of the user with respect to the mobility device; and a third communication unit configured to open a storage space of the mobility device when the authentication of the user is completed and to cause the mobility device to move to a delivery destination point set by the user when loading of the baggage of the user is completed.

In other form, the present disclosure provides a delivery system using an autonomous mobility device which is configured to perform an autonomous driving and in which a storage space thereof is divided into sectors according to a use purpose. In particular, the delivery system includes: a searching unit configured to receive information about use of a specific sector of the storage space in a mobility device selected by a user; a first communication unit configured to cause the selected mobility device to move to the user; a second communication unit configured to check authentication of the user with respect to the mobility device; and a third communication unit configured to open the storage space of the mobility device when the authentication of the user is completed and to cause the mobility device to move to a delivery destination point set by the user when loading of the baggage into a specific sector selected by the user is completed.

In the delivery method and system using an autonomous mobility device having the structure as described above, a delivery service is provided using the autonomous mobility device, reliability based on use of the delivery service through an authentication procedure between the mobility device and a user is secured, and thus a sense of satisfaction of the delivery service is improved by satisfying a delivery request made by the user.

### BRIEF DESCRIPTION OF THE DRAWINGS

The above and other objects, features and other advantages of the present disclosure should be more clearly understood from the following detailed description when taken in conjunction with the accompanying drawings, in which:

FIG. 1 is a diagram illustrating an autonomous mobility device having a storage space;

FIG. 2 is a flow chart of a delivery method using an autonomous mobility device according to an embodiment of the present disclosure;

FIG. 3 is a flow chart of a delivery method using an autonomous mobility device according to another embodiment of the present disclosure;

FIG. 4 is a diagram illustrating an autonomous mobility device in which a storage space is divided into sectors according to a use purpose; and

FIG. 5 is a configuration diagram of a delivery system using an autonomous mobility device according to the present disclosure.

The drawings described herein are for illustration purposes only and are not intended to limit the scope of the present disclosure in any way.

### DETAILED DESCRIPTION

Hereinafter, a delivery method and a system using an autonomous mobility device according to exemplary embodiments of the present disclosure are described with reference to the accompanying drawings.

The following description is merely exemplary in nature and is not intended to limit the present disclosure, application, or uses. It should be understood that throughout the drawings, corresponding reference numerals indicate like or corresponding parts and features.

As publicly known in the art, some of exemplary forms may be illustrated in the accompanying drawings from the viewpoint of function blocks, units and/or modules. Those having ordinary skill in the art should understand that such blocks, units and/or modules are physically implemented by electronic (or optical) circuits such as logic circuits, discrete components, processors, hard wired circuits, memory devices and wiring connections. When the blocks, units and or modules are implemented by processors or other similar hardware, the blocks, units and modules may be programmed and controlled through software (for example, codes) in order to perform various functions discussed in the present disclosure.

When a component, device, element, or the like of the present disclosure is described as having a purpose or performing an operation, function, or the like, the component, device, or element should be considered herein as being “configured to” meet that purpose or to perform that operation or function.

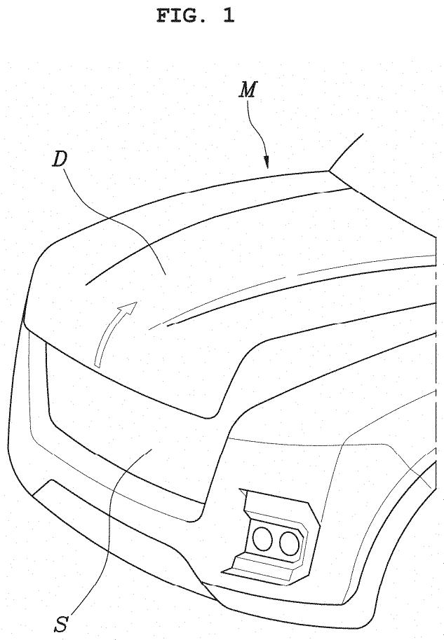

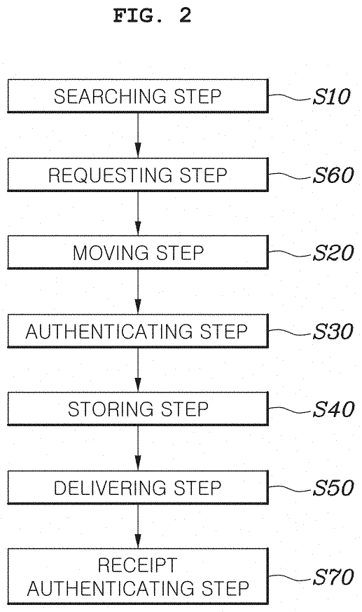

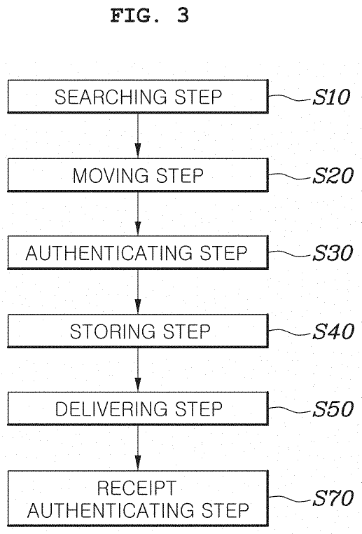

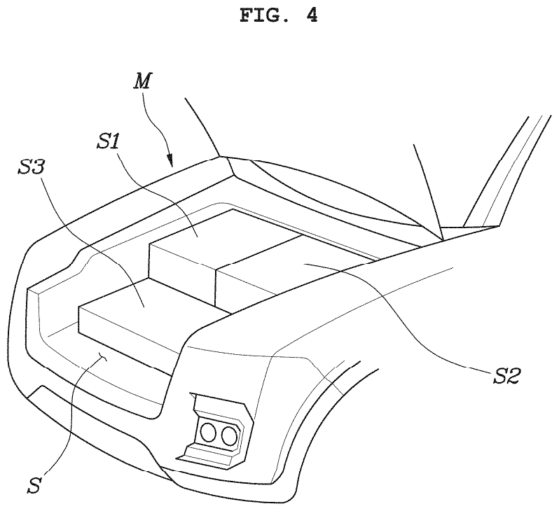

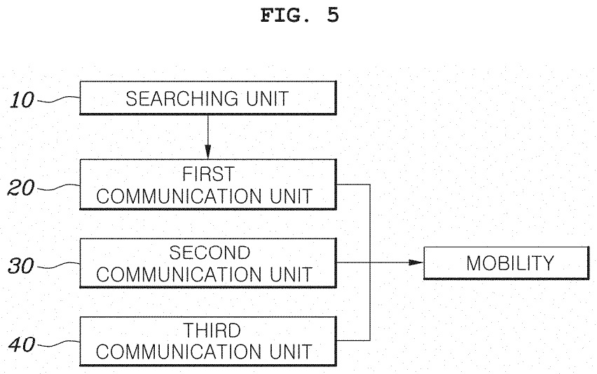

FIG. 1 is a diagram illustrating an autonomous mobility device having a storage space according to one embodiment of the present disclosure. FIG. 2 is a flow chart of a delivery method using an autonomous mobility device according to another embodiment of the present disclosure. FIG. 3 is a flow chart of a delivery method using an autonomous mobility device according to another embodiment of the present disclosure. FIG. 4 is a diagram illustrating an autonomous mobility device in which a storage space is divided into sectors according to a use purpose according to one embodiment of the present disclosure. FIG. 5 is a configuration diagram of a delivery system using an autonomous mobility device according to another embodiment of the present disclosure.

The present disclosure relates to a delivery method using an autonomous mobility device that is configured to enable autonomous driving and has a storage space, wherein the autonomous mobility device is configured to enable complete autonomous driving and to have a storage space.

As illustrated in FIG. 1, a mobility device “M” has a storage space “S”, such as a frunk, a trunk, an indoor space, or the like, in which a baggage can be stored, and so on. The storage space can be opened or closed by a door “D” that is opened or closed through automatic control.

Moreover, as the complete autonomous driving is possible, the mobility device may be moved to a specific delivery destination point through satellite communication.

As illustrated in FIG. 2, the delivery method using an autonomous mobility device includes: a searching step S10 of searching a mobility device into which a baggage can be loaded on the basis of baggage information set by a user, a moving step S20 of causing the searched mobility device to move to the user, an authenticating step S30 of checking authentication of the user with respect to the mobility device, a storing step S40 of opening a storage space of the mobility device when the authentication of the user is completed, and a delivering step S50 of closing the storage space when the loading of the baggage of the user into the mobility device is completed, and causing the mobility device to move to a delivery destination point set by the user.

In the searching step S10, when the user inputs baggage information and requested delivery information, a mobility device satisfying the baggage information and the requested delivery information is searched.

For example, the user may set baggage information and requested delivery information through a website or a mobile terminal, search a mobility device satisfying the set baggage information and requested delivery information, and then check whether or not to use the searched mobility device.

In the searching step S10, the baggage information based on weight and a size of the baggage is input from a user, and a mobility device into which the baggage input by the user can be loaded may be searched.

In this way, when the user inputs the baggage information based on the weight and the size of the baggage, the mobility device into which the baggage set by the user can be loaded is searched, thereby enabling stable delivery of the baggage through the mobility device.

In the searching step S10, when the weight of the baggage set by the user is heavy or the size of the baggage set by the user is large, a large mobility device that can stably store the baggage may be searched. When the weight of the baggage set by the user is light or the size of the baggage set by the user is small, a small mobility device may be searched.

Here, in the searching step S10, a mobility device, in which a baggage selected by the user can be loaded into a specific sector of the storage space thereof, may be searched.

The storage space of the mobility device may be divided into sectors according to a use purpose, for example a temperature control space into which a baggage requiring a specific temperature is loaded, a shock absorbing space into which a baggage requiring a minimum shock is loaded, a basic space into which an ordinary baggage is loaded, and so on.

In this way, in the searching step S10, when use of the specific sector of the storage space of the mobility device is desired depending on the baggage of the user, a mobility device, in which the baggage can be loaded into the specific sector of the storage space thereof, is searched and provided to the user.

Further, in the searching step S10, information about delivery departure and destination points is input, a mobility device capable of moving to the delivery destination point via the delivery departure point is searched.

That is, when the delivery departure point is input in the searching step S10, a mobility device that goes by way of the delivery departure point or exists within a range of a given distance from the delivery departure point may be searched. In addition, when the delivery destination point is input, a mobility device that goes by way of the delivery destination point or arrives within a range of a given distance from the delivery destination point may be searched.

In this way, the searching step S10 searches the mobility device that satisfies both information about the delivery departure point and information about the delivery destination point, and thereby the mobility device can be efficiently selected.

Further, in the searching step S10, requested delivery information about a delivery departure time and a delivery arrival expected time of a user is input.

In this way, the requested delivery information about a delivery departure time and a delivery arrival expected time of a user is input. Thereby, any mobility device may be provided according to a delivery departure time which the user wants, and a mobility device that is movable from the delivery departure time to the delivery arrival expected time may be selected.

Further, in the searching step S10, the requested delivery information about express or slow delivery when the baggage is delivered is input.

That is, a case where a user wants the express delivery at the time of delivery using a mobility device may occur. Accordingly, in the searching step S10, the requested delivery information about express or slow delivery when a baggage is delivered is input, and thereby a delivery service requested by a user can be provided.

Further, an additional charge can be exactly calculated with respect to an express mobility device through the searching step S10.

In addition, in the searching step S10, an independent mobility device or a common mobility device may be selected by a user according to importance of a baggage, and an addition charge may be exactly calculated when the independent mobility device is selected. That is, when security importance of a baggage is high, a user can select the independent mobility device to provide express and safe delivery, and in the case of an ordinary baggage, the user may select the common mobility device to use a delivery service at a low price.

In this way, in the searching step S10, a suitable mobility device is filtered depending on the baggage information and the requested delivery information, and an optimum mobility device satisfying a request of a user is searched. Thereby, a feeling of satisfaction of the delivery service using the mobility device is improved.

Meanwhile, when a movable mobility device is searched through the searching step S10, a requesting step S60 of transmitting information about a charge to be paid in using the searched mobility device to the user is further included.

That is, information about a charge to be paid when a delivery service using a mobility device is used is transmitted to the user through the requesting step S60, and thereby the user can determine whether or not to use the searched mobility device according to the charge of the searched mobility device.

In this way, when the user permits delivery using the searched mobility device in the requesting step S60, the moving step S20 causes the searched mobility device to move to the user and enables the user to use the delivery service using a mobility device.

In this case, in the moving step S20, the mobility device may be made to move to a user who makes a request for the delivery service in an autonomous driving mode under the control of the mobility device.

In the case of the requesting step S60, if the user makes use of a commuter pass or a subscription service based on the use of the mobility device, the requesting step S60 may not be performed. Accordingly, as illustrated in FIG. 3, the moving step S20 is performed after the searching step S10.

Meanwhile, when the mobility device is moved to the user through the moving step S20, the authenticating step S30 of checking authentication of the user with respect to the mobility device is performed.

In the authenticating step S30, an authentication code may be input by a user and be transmitted to the user when determining the use of the delivery service, or an authentication procedure may be performed through near-field communication (NFC), fingerprint recognition, facial recognition, iris recognition, or the like.

As the authenticating step S30 is performed in this way, users other than the user who makes a request for the mobility device for delivery fail to confirm the storage space of the mobility device. Accordingly, theft is prevented, and reliability is secured.

In this way, when the authentication of the user with respect to the mobility device is completed through the authenticating step S30, the storing step S40 of opening a storage space of the mobility device is performed and makes it possible to load a baggage into the storage space of the mobility device.

Here, in the storing step S40, a previous baggage loaded into the mobility device before the storage space of the mobility device is opened is checked, and it is identified whether or not the previous baggage is changed after the storage space of the mobility device is opened.

That is, when the storage space of the mobility device is used in common, there is a chance of theft, and thus the previous baggage loaded into the mobility device before the storage space is opened is checked. In this case, to check a change in the previous baggage loaded into the storage space of the mobility device, a method of detecting a change in weight or a method of identifying a position of each baggage through a laser sensor or a camera sensor may be applied.

In this way, in the storing step S40, the previous baggage loaded into the mobility device before the storage space of the mobility device is opened is checked, and it is identified whether or not the previous baggage after the storage space of the mobility device is opened is changed. When it is identified that the previous baggage is changed, a theft warning signal is generated.

That is, since the storage space of the mobility device is opened when the authentication of the user with respect to the mobility device is completed, the theft warning signal can be generated for the mobility device and the authenticated user. This theft warning signal can generate a warning sound at the mobility device, or transmit a warning message through a terminal carried by the user.

In addition, when it is identified that the previous baggage is changed in the storage space of the mobility device, rapid measures against the theft of the baggage can be taken through a receipt of a theft report.

Further, in the storing step S40, when the user loads a baggage into the storage space of the mobility device, the baggage loaded by the user is checked, and it is checked whether the loaded baggage is identical to the baggage information input by the user. When the loaded baggage is different from the input baggage information, anon-identical warning signal is generated.

In this case, the baggage loaded into the storage space of the mobility device may be identified by detecting a change in weight or through a laser sensor or a camera sensor.

In this way, when the baggage loaded by the user is different from the input baggage information, the non-identical warning signal is transmitted to the user, and thus the user can recognize that the baggage different from the input baggage information is loaded. Here, the non-identical warning signal may be transmitted as a warning sound or a warning message through a mobile terminal.

The delivering step S50 of closing the storage space of the mobility device when the loading of the baggage into the storage space of the mobility device is completed through this process, and causing the mobility device to move to a delivery destination point set by the user is performed. In this case, the mobility device is moved to the delivery destination point set by the user through autonomous driving.

Here, it may be identified through various sensors provided in the storage space whether or not the baggage is loaded into the storage space of the mobility device. In this way, when the loading of the baggage into the storage space of the mobility device is completed, the mobility device closes the storage space by command of the user or automatically. When the storage space is closed, the mobility device is made to move to the delivery destination point through autonomous driving.

Meanwhile, when the delivery of the baggage to the delivery destination point after the delivering step S50 is completed, receipt authentication is requested a recipient. When the receipt authentication is completed, a receipt authenticating step S70 of opening the storage space of the mobility device is further included.

That is, when the mobility device into which the baggage is loaded is moved to the recipient, the recipient performs authentication on the mobility device. The authentication of the recipient may be performed by inputting an authentication code transmitted to the recipient or by recognizing a fingerprint, a face, an iris, or the like.

In this way, when the authentication is performed on the recipient and the receipt authentication is completed through the receipt authenticating step S70, the storage space of the mobility device is opened only to the recipient, and thus theft is prevented and reliability is secured.

Meanwhile, as another embodiment, autonomous driving is configured to be made possible, and control over the mobility device in which the storage space thereof is divided into sectors according to the use purpose may be performed.

That is, as illustrated in FIG. 4, the storage space S of the mobility device M is divided into sectors according to the use purpose, and thereby baggage(s) may be loaded into the sectors.

The storage space S of the mobility device M may be divided into sectors according to the use purpose, for example a temperature control space S1 into which a baggage requiring a specific temperature is loaded, a shock absorbing space S2 into which a baggage requiring a minimum shock is loaded, a basic space S3 into which an ordinary baggage is loaded, and so on.

Further, as required authentication codes are different, a baggage may be loaded into each of the storage spaces only for a user, authentication of which is completed.

As the mobility device enables complete autonomous driving, the mobility device can be moved to a specific delivery destination point through satellite communication.

In one form, the delivery method using an autonomous mobility device of the present disclosure includes: a searching step S10 of receiving use information about a specific sector of a storage space at a mobility device selected by a user, a moving step S20 of causing the selected mobility device to move to the user, an authenticating step S30 of checking authentication of the user with respect to the mobility device, a storing step S40 of opening the storage space of the mobility device when the authentication of the user is completed, and a delivering step S50 of causing the mobility device to move to a delivery destination point set by the user when loading of a baggage into a specific sector selected by the user is completed.

In one form, in the searching step S10, the use information about the specific sector of the storage space in the mobility device selected by a user is received.

That is, the user may select a storage space for a specific use purpose provided in the mobility device according to a baggage which a user intends to deliver through a website or a mobile terminal, and may search a mobility device having the storage space for the input specific use purpose to check whether or not to use the searched mobility device to the user.

Meanwhile, when the use information about the specific sector of the storage space in the mobility device is input through the searching step S10, a requesting step S60 of transmitting information about a charge to be paid in using the input specific sector to the user is further included.

That is, when a delivery service using a mobility device is used through the requesting step S60, the information about the charge to be paid to use the specific sector of the storage space is transmitted to the user, and thereby the user may determine whether or not to use the mobility device according to the charge to be paid to use the specific sector of the storage space.

In this way, when delivery where the user makes use of the mobility device is permitted in the requesting step S60, the selected mobility device is made to move to the user in the moving step S20 so that the user may be made to use the delivery service using the mobility device.

Meanwhile, when the mobility device is moved to the user through the moving step S20, the authenticating step S30 of checking authentication of the user with respect to the mobility device is performed.

In the authenticating step S30, an authentication code transmitted to the user when the user determines the use of the delivery service may be input, or an authentication procedure may be performed through near-field communication (NFC), fingerprint recognition, facial recognition, iris recognition, or the like.

In this way, when the authentication of the user with respect to the mobility device is completed through the authenticating step S30, the storing step S40 of opening a storage space of the mobility device is performed and makes it possible to load a baggage into the storage space of the mobility device.

In this way, when the user loads the baggage into the storage space of the mobility device, the delivering step S50 of closing the storage space of the mobility device and moving the mobility device to a delivery destination point set by the user is performed. In this case, the mobility device is moved to the delivery destination point set by the user through autonomous driving.

That is, when the loading of the baggage into the storage space of the mobility device is completed, the mobility device closes the storage space by command of the user or automatically. When the storage space is closed, the mobility device is made to move to the delivery destination point through autonomous driving.

Meanwhile, a delivery system using an autonomous mobility device that is configured to enable autonomous driving and has a storage space includes, as illustrated in FIG. 5, a searching unit 10 that receives baggage information and requested delivery information set by a user and searches a movable mobility device, a first communication unit 20 that causes the searched mobility device to move to the user, a second communication unit 30 that checks authentication of the user with respect to the mobility device, and a third communication unit 40 that opens a storage space of the mobility device when the authentication of the user is completed and causes the mobility device to move to a delivery destination point set by the user when loading of a baggage of the user is completed.

When the user inputs the baggage information and the requested delivery information through a website or a mobile terminal, the searching unit 10 searches a mobility device that can be provided on the basis of the information.

In this way, when the mobility device is searched, the first communication unit 20 communicates with the searched mobility device and causes the searched mobility device to move to the user. Accordingly, the mobility device can be moved to the user through autonomous driving.

Meanwhile, when the mobility device arrives at the user, the second communication unit 30 receives the authentication of the user with respect to the mobility device.

In this way, when it is checked that the authentication of the user with respect to the mobility device is normally performed in the second communication unit 30, the third communication unit 40 transmits a signal to the mobility device and causes the storage space to be opened.

For this reason, the user can load a baggage into the storage space of the mobility device, and when the loading of the baggage is completed, the third communication unit 40 performs communication to cause the mobility device to move to the delivery destination point set by the user.

In another embodiment, a delivery system using an autonomous mobility device, which is configured to enable autonomous driving and in which a storage space thereof is divided into sectors according to a use purpose, includes a searching unit 10 that receives information about use of a specific sector of the storage space in a mobility device selected by a user, a first communication unit 20 that causes the selected mobility device to move to the user, a second communication unit 30 that checks authentication of the user with respect to the mobility device, and a third communication unit 40 that opens the storage space of the mobility device when the authentication of the user is completed and causes the mobility device to move to a delivery destination point set by the user when loading of a baggage into the specific sector selected by the user is completed.

In other words, the storage space of the mobility device is divided into sectors according to the use purpose, and thereby the baggage can be loaded according to each sector. Accordingly, the user may select the storage space of the mobility device which is suitable for the baggage through a website or a mobile terminal.

Accordingly, the searching unit 10 receives information about use of the specific sector of the storage space in the mobility device selected by the user.

The first communication unit 20 communicates with the selected mobility device through the searching unit 10 and causes the mobility device to move to the user. Accordingly, the mobility device may be caused to move to the user through autonomous driving.

Meanwhile, when the mobility device arrives at the user, the user performs authentication on a specific sector selected by the user within the storage space of the mobility device, and the resultant authentication is transmitted to the second communication unit 30.

In this way, when it is checked that the authentication of the user is normally performed and completed in the second communication unit 30, the third communication unit 40 transmits a signal such that the specific sector selected by the user within the storage space of the mobility device is opened.

For this reason, the user may load a baggage into the specific sector in the storage space of the mobility device, and when the loading of the baggage is completed, the third communication unit 40 performs communication such that the mobility device is moved to the delivery destination point set by the user.

In the delivery method and system using an autonomous mobility device having the structure as described above, a delivery service is provided using the autonomous mobility device, reliability based on use of the delivery service through an authentication procedure between the mobility device and a user is secured, and a sense of satisfaction of the delivery service is improved by satisfying a delivery request made by the user.

While the specific exemplary embodiment of the present disclosure has been illustrated and described, it should be apparent to those having ordinary skill in the art that the present disclosure may be variously improved and changed without departing from the technical spirit of the present disclosure.

What is claimed is:

1. A delivery method using a mobility device that is configured to perform an autonomous driving and has a storage space, the delivery method comprising:
a searching step of searching the mobility device into which a baggage is loadable based on baggage information set by a user;
a moving step of causing the mobility device to move to the user;
an authenticating step of checking authentication of the user with respect to the mobility device;
a storing step of opening the storage space of the mobility device when the authentication of the user is completed; and
a delivering step of closing the storage space when loading of the baggage of the user into the mobility device is completed, and causing the mobility device to move to a delivery destination point set by the user.

2. The delivery method according to claim 1,
wherein the searching step comprises: receiving the baggage information including a weight of the baggage and a size of the baggage from the user.

3. The delivery method according to claim 2,
wherein the searching step comprises searching the mobility device in which the baggage is loadable into a specific sector of the storage space of the mobility device selected by the user.

4. The delivery method according to claim 1,
wherein the searching step comprises: receiving information including a delivery departure point and a delivery destination point, and searching the mobility device that is movable to the delivery destination point via the delivery departure point.

5. The delivery method according to claim 1,
wherein the searching step comprises receiving requested delivery information including a delivery departure time and an expected delivery arrival time from the user.

6. The delivery method according to claim 1,
wherein the searching step comprises receiving, from the user, requested delivery information including an express or slow delivery set by the user to deliver the baggage.

7. The delivery method according to claim 1,
wherein the searching step comprises receiving, from the user, requested delivery information indicating whether to use an independent mobility device or a common mobility device.

8. The delivery method according to claim 1, further comprising:
a requesting step of, when the mobility device is searched through the searching step, transmitting information about a charge to be paid in using the mobility device to the user.

9. The delivery method according to claim 8,
wherein the moving step comprises: causing the mobility device to move to the user when the user permits delivery using the mobility device in the requesting step.

10. The delivery method according to claim 1,
wherein the storing step comprises: checking a previous baggage loaded into the mobility device before the storage space of the mobility device is opened, and identifying whether or not the previous baggage is changed after the storage space of the mobility device is opened.

11. The delivery method according to claim 10,
wherein the storing step comprises: generating a theft warning signal when it is identified that the previous baggage is changed.

12. The delivery method according to claim 1,
Wherein the storing step comprises:
when the user loads the baggage in the storage space of the mobility device, checking the baggage loaded by the user
checking whether the loaded baggage is identical to the baggage information set by the user, and
generating a non-identical warning signal when the loaded baggage is different from the baggage information set by the user.

13. The delivery method according to claim 1, further comprising:
a receipt authenticating step of requesting receipt authentication to a recipient when delivery of the baggage to the delivery destination point is completed after the delivering step, and
opening the storage space of the mobility device when the receipt authentication is completed.

14. A delivery method using a mobility device which is configured to perform an autonomous driving and in which a storage space thereof is divided into sectors according to a use purpose, the delivery method comprising:
a searching step of receiving information about use of a specific sector of the storage space in the mobility device selected by a user;
a moving step of causing the selected mobility device to move to the user;
an authenticating step of checking authentication of the user with respect to the mobility device;
a storing step of opening the storage space of the mobility device when the authentication of the user is completed; and
a delivering step of causing the mobility device to move to a delivery destination point set by the user when loading of a baggage into a specific sector selected by the user is completed.

15. The delivery method according to claim 14,
further comprising: a requesting step of, when the information about use of the specific sector of the storage space in a mobility device is input through the searching step, transmitting information about a charge to be paid in using the specific sector of the storage space to the user,
wherein the moving step comprises: causing the selected mobility device to move to the user when the user permits delivery using the specific sector through the requesting step.

16. A delivery system using a mobility device that is configured to perform an autonomous driving and has a storage space, the delivery system comprising:
a searching unit configured to receive baggage information and requested delivery information set by a user to search the mobility device;
a first communication unit configured to cause the searched mobility device to move to the user;
a second communication unit configured to check authentication of the user with respect to the searched mobility device; and
a third communication unit configured to open the storage space of the searched mobility device when the authentication of the user is completed and configured to cause the searched mobility device to move to a delivery destination point set by the user when loading of the baggage of the user is completed.

17. A delivery system using a mobility device which is configured to perform an autonomous driving and in which a storage space thereof is divided into sectors according to a use purpose, the delivery system comprising:
a searching unit configured to receive information about use of a specific sector of the storage space in the mobility device selected by a user;
a first communication unit configured to cause the selected mobility device to move to the user;
a second communication unit configured to check authentication of the user with respect to the selected mobility device; and
a third communication unit configured to open the storage space of the selected mobility device when the authentication of the user is completed and configured to cause selected the mobility device to move to a delivery destination point set by the user when loading of a baggage into the specific sector selected by the user is completed.
